(19) United States
(12) Patent Application Publication
(10) Pub. No.: US 2026/0308957 A1
(43) Pub. Date: Oct. 8, 2026

(54) ADJUSTABLE DOORSTOP WITH PIVOTING POSITIONING ARM

(71) Applicants: Robert Charles Wisner, JR., Washington, UT (US); Valeri Joan Wisner, Washington, UT (US)

(72) Inventors: Robert Charles Wisner, JR., Washington, UT (US); Valeri Joan Wisner, Washington, UT (US)

(21) Appl. No.: 19/555,496

(22) Filed: Mar. 3, 2026

Related U.S. Application Data
(60) Provisional application No. 63/784,716, filed on Apr. 7, 2025.

(51) Int. Cl. E05C 17/00

(52) U.S. Cl. CPC E05C 17/025

(57) ABSTRACT

A doorstop includes an outer body and an inner positioning arm. The outer body has a first surface for abutting a first side of a door, a second surface for abutting an edge of the door, and a plurality of positioning notches. The inner positioning arm has an arm surface for abutting a doorjamb and one or more protrusions for selectively mating with a positioning notch of the plurality of positioning notches. The protrusions and positioning notches are configured to set an angle of the door when in an open position.

### CROSS-REFERENCE TO RELATED APPLICATIONS

This application claims the benefit of U.S. Provisional Application No. 63/784,716, filed on Apr. 7, 2025, which is hereby incorporated by reference in its entirety.

### FIELD OF INVENTION

The present disclosure relates to doorstops for propping open doors, and more particularly, to an adjustable doorstop for setting the angle of a door when in an open position.

### BACKGROUND

Self-closing doors, such as those equipped with spring-biased hinges or hydraulic door closers, have become prevalent in both commercial and residential settings, providing benefits related to security, fire safety, and convenience. However, numerous situations arise in which it is desirable to maintain a door in an open position, such as when moving furniture or other items through a doorway, when delivery personnel are transporting goods into a building, or when first responders require unimpeded access during emergency situations. These same problems may occur with non-spring-biased doors as well, where a user wishes to maintain the door in an open position that will not be subject to closing due to outside forces, such as wind, etc.

Various doorstop devices have been developed to address the need for holding doors open. One common approach involves placing a heavy object against the door to resist the closing force of the spring or hydraulic mechanism. While straightforward in concept, such objects present tripping hazards, require storage space when not in use, and may cause back strain when repeatedly placed and removed.

Rubber wedge doorstops represent another conventional solution, wherein a wedge-shaped piece of rubber or similar material is inserted between the bottom edge of the door and the floor surface. The downward force of the door against the wedge creates friction that resists door movement. However, wedge-type doorstops exhibit reduced effectiveness on smooth floor surfaces such as tile, marble, or polished concrete, where insufficient friction may allow the wedge to slide. Additionally, wedge doorstops are ineffective when the floor surface is stepped, angled, or otherwise irregular, such as when a ramp is present at the doorway. Additionally, these wedge doorstops require bending, which may cause back strain when repeatedly placed and removed.

Hinge-mounted door stops have also been developed, which attach to, or engage with, door hinges to limit door movement. While these devices avoid some of the drawbacks associated with floor-based doorstops, they may require permanent installation, modification of existing hardware, or complex mechanisms that increase cost and reduce reliability.

Accordingly, there remains a need for doorstop devices that do not require placement of heavy objects, that avoid creating tripping hazards, that function independently of floor surface characteristics, and that provide adjustable positioning to accommodate different door opening angles. The present disclosure seeks to solve these and other problems.

### SUMMARY

This summary is provided to introduce a selection of concepts in a simplified form that are further described below in the detailed description.

According to some aspects of the present disclosure, a doorstop comprises an outer body and an inner positioning arm. The outer body has a first surface for abutting a first side of a door, a second surface for abutting an edge of the door, and a plurality of positioning notches. The inner positioning arm has an arm surface for abutting a doorjamb and one or more protrusions for selectively mating with a notch of the plurality of positioning notches. The protrusions and positioning notches are configured to set the angle of the door when in an open position.

In some embodiments, the inner positioning arm may be received within a slot in the outer body. The inner positioning arm may include a coupling aperture that aligns with a coupling aperture of the outer body, and a rod may be inserted through the coupling apertures to couple the inner positioning arm to the outer body. The rod may function as a pivot point, allowing the inner positioning arm to pivot in relation to the outer body. The plurality of positioning notches may include a first notch, a second notch, and a third notch. The one or more protrusions may include a first protrusion and a second protrusion. The protrusions may be configured to engage with the first notch in a first position, wherein the arm surface extends from the outer body at a first distance, setting a first angle. The protrusions may be configured to engage with the second notch in a second position, wherein the arm surface extends from the outer body at a second distance greater than the first distance, setting a second angle. The protrusions may be configured to engage with the third notch in a third position, wherein the arm surface extends from the outer body at a third distance greater than the second distance, setting a third angle. The doorstop may be configured to be interposed between the door and the doorjamb on a hinge side of the door.

In some embodiments, a method of using a doorstop comprises determining a desired angle of a door. The method includes actuating an inner positioning arm within an outer body so that corresponding protrusions mate with selected positioning notches. The method includes opening the door and inserting the doorstop on a hinge side of the door, interposing the doorstop between the door and a doorjamb.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a left side perspective view of a doorstop, according to aspects of the present disclosure.

FIG. 2 illustrates a right side perspective view of a doorstop, according to aspects of the present disclosure.

FIG. 3 illustrates a left side exploded perspective view of a doorstop, according to aspects of the present disclosure.

FIG. 4 illustrates a rear perspective view of an inner positioning arm of a doorstop, according to aspects of the present disclosure.

FIG. 5 illustrates a front perspective view of the inner positioning arm of a doorstop, according to aspects of the present disclosure.

FIG. 6 illustrates a front perspective view of an outer body of a doorstop, according to aspects of the present disclosure.

FIG. 7 illustrates a right side perspective view of the outer body of a doorstop, according to aspects of the present disclosure.

FIG. 8 illustrates a bottom perspective view of the outer body of a doorstop, according to aspects of the present disclosure.

FIG. 9 illustrates a left side elevation view of a doorstop in a first position, according to aspects of the present disclosure.

FIG. 10 illustrates a left side elevation view of a doorstop in a second position, according to aspects of the present disclosure.

FIG. 11 illustrates a left side elevation view of a doorstop in a third position, according to aspects of the present disclosure.

FIG. 12 illustrates a right side perspective view of a doorstop in a first position in use with a door and a doorjamb, according to aspects of the present disclosure.

FIG. 13 illustrates a right side perspective view of a doorstop in a third position in use with a door, according to aspects of the present disclosure.

FIG. 14 illustrates a top perspective view of a doorstop with a holster, according to aspects of the present disclosure.

FIG. 15 illustrates a left perspective view of a doorstop with a holster, according to aspects of the present disclosure.

FIG. 16 illustrates a right perspective view of a doorstop with a holster, according to aspects of the present disclosure.

### DETAILED DESCRIPTION

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there is a need in the art for a doorstop which does not require bending and placing heavy objects, does not create a tripping hazard, works on most door types, and that is not dependent on the ground surface type or angle. The doorstop disclosed herein solves these and other problems.

A doorstop according to the present disclosure may be configured to hold doors in open positions. The doorstop may be configured to work with self-closing doors, including self-closing doors having spring-biased hinges and self-closing doors having hydraulic arms, and standard, non-self closing doors. The doorstop may be interposed between a door and a doorjamb on a hinge side of the door, thereby maintaining the door in a desired open position without relying on ground contact. Because the doorstop does not contact the ground during operation, the doorstop does not create a tripping hazard during use. The doorstop is not dependent on the ground surface type or angle for operation, allowing the doorstop to function on smooth surfaces such as tiles and marble, as well as on stepped or angled surfaces such as ramps. The doorstop does not require bending and placing or the use of heavy objects for operation, thereby reducing physical strain on users during installation and removal of the doorstop.

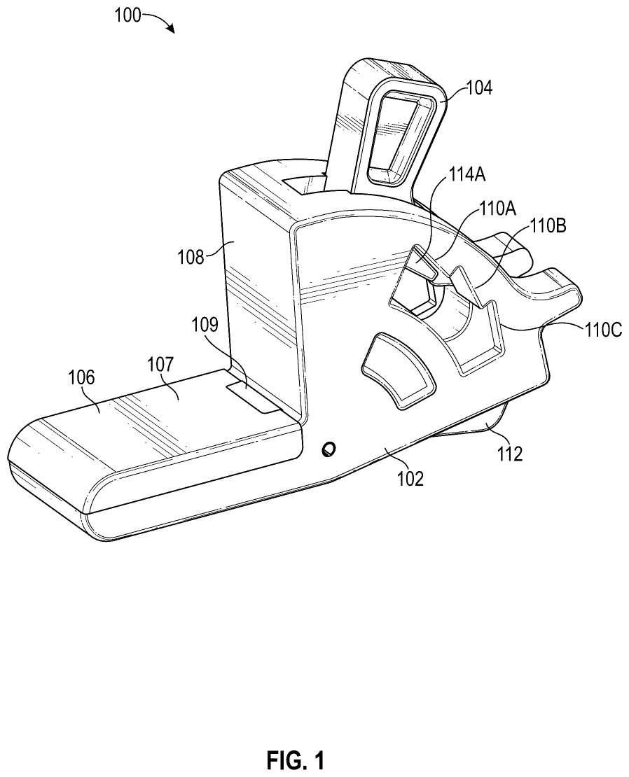

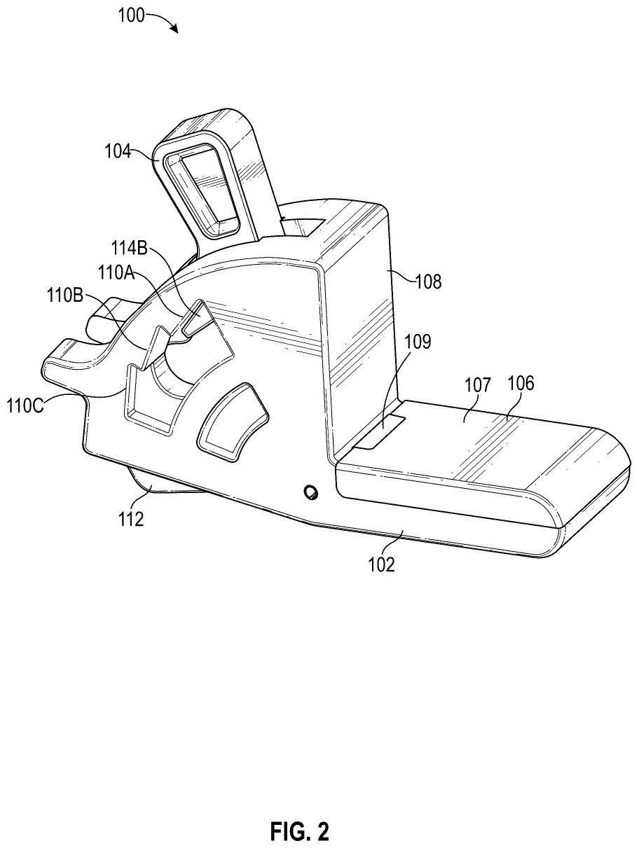

Referring to FIG. 1 and FIG. 2, a doorstop 100 may comprise an outer body 102 and an inner positioning arm 104. The outer body 102 and the inner positioning arm 104 may be configured to cooperate to hold a door at a selected angle when the door is in an open position.

The outer body 102 may include a first surface 106, a second surface 108, and a plurality of positioning notches 110A-C. The first surface 106 may be configured for abutting a first side of a door. The first surface 106 may comprise a non-abrasive surface 107 (e.g., rubber, foam, plastic, etc.) so as to ensure that the door is not damaged when contacting the first surface 106. The non-abrasive surface may be removably attachable, such as via release lever 109 or other mechanisms. In some embodiments, the non-abrasive surface 107 is secured to the first surface 106 by a snap-fit or cam-lock retained by a release lever 109 that, when actuated, permits tool-less removal and replacement of the non-abrasive surface 107.

The second surface 108 may be configured for abutting an edge of the door. As shown in FIG. 1 and FIG. 2, the outer body 102 may have an L-shaped configuration, with the first surface 106 forming a horizontal portion and the second surface 108 forming a vertical portion.

With continued reference to FIG. 1 and FIG. 2, the plurality of positioning notches 110A-C may include a first positioning notch 110A, a second positioning notch 110B, and a third positioning notch 110C. The first positioning notch 110A, the second positioning notch 110B, and the third positioning notch 110C may be arranged in a sequential manner along the outer body 102. The positioning notches 110A, 110B, 110C may be arranged in a curved configuration along the outer body 102.

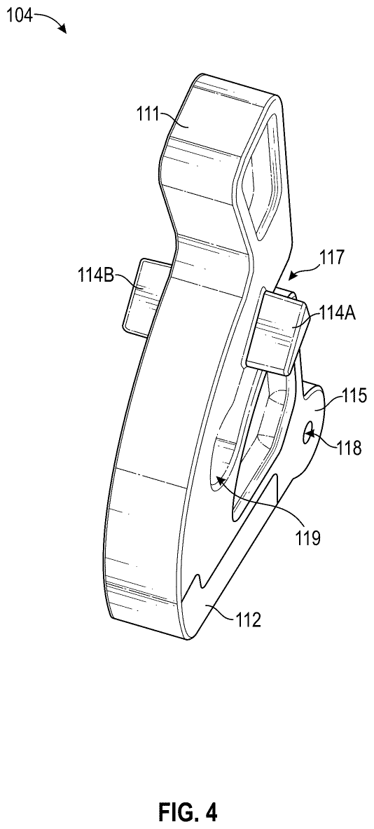

The inner positioning arm 104 extends from within the outer body 102. The inner positioning arm 104 may include an arm surface 112 that extends from within the outer body 102 and is configured for abutting a doorjamb, and one or more protrusions 114A-B (best seen in FIG. 4). The one or more protrusions 114A-B are configured to selectively mate with one of the positioning notches 110A, 110B, or 110C to set the angle of a door when in an open position. The selective engagement between the one or more protrusions 114A-B and the positioning notches 110A, 110B, 110C may allow a user to adjust the doorstop 100 to hold a door at different angular positions by setting how much of the arm surface 112 protrudes from the outer body 102. The arm surface 112 may comprise a non-abrasive surface 113 so as to avoid scratching or damaging the doorjamb when engaged therewith.

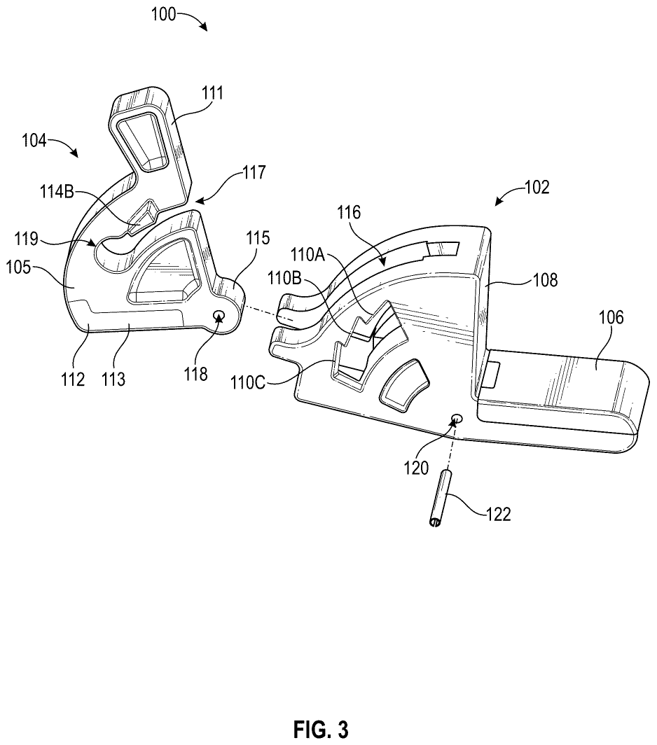

Referring to FIG. 3, an exploded perspective view of the doorstop 100 illustrates the relationship between the outer body 102 and the inner positioning arm 104 in a disassembled state. The outer body 102 includes a slot 116 configured to receive the inner positioning arm 104. Referring to FIGS. 3-5, the inner positioning arm 104 comprises a main body 105, a handle 111, and a fulcrum portion 115. As shown, the handle 111 is positioned on an opposite side of the main body 105 from the fulcrum portion 115. The fulcrum portion 115 comprises a coupling aperture 118. As shown, a first protrusion 114A extends outwardly from a first side of the main body 105 and the second protrusion 114B extends from an opposite side of the main body 105, each protrusion 114A-B extending in a perpendicular direction to the handle 111.

The outer body 102 may include a coupling aperture 120 proximal to the intersection of the first surface 106 and second surface 108. When the inner positioning arm 104 is positioned within the slot 116, the coupling aperture 118 of the fulcrum 115 of the inner positioning arm 104 may align with the coupling aperture 120 of the outer body 102. A rod 122 may be configured to be inserted through the coupling aperture 118 and the coupling aperture 120 to pivotably couple the inner positioning arm 104 to the outer body 102. The rod 122 thereby functions as a pivot point, allowing the inner positioning arm 104 to pivot in relation to the outer body 102. The pivoting arrangement enables the inner positioning arm 104 to be adjusted to different positions relative to the outer body 102, thereby setting different angles for a door when the doorstop 100 is in use.

The main body 105 includes an aperture 117 positioned between the handle 111 and the fulcrum 115. The aperture 117 extends toward the arm surface 112 and includes a circular portion 119. The geometry of the aperture 117, including the circular portion 119, allows the material of the main body 105 to elastically deform when a user applies force to the handle 111. This elastic deformation permits the protrusions 114A-B to disengage from a selected one of the positioning notches 110A-C. When the user releases the applied force, the circular portion 119 facilitates the return of the handle 111 to its original position, thereby re-engaging the protrusions 114A-B with a selected positioning notch 110A-C. The main body 105 may be formed from an elastomeric or semi-rigid polymer that provides a natural biasing force to maintain the protrusions 114A-B in engagement with a selected positioning notch 110A-C during operation. In some embodiments, the circular portion 119 may be replaced by an alternative stress-relief geometry (e.g., oval, elliptical, or polygonal terminus) configured to provide similar elastic-return behavior without a separate spring component.

As understood, when the protrusions 114A-B are positioned in the first positioning notch 110A, the arm surface 112 extends from the outer body 102 in a first, minimal position, positioning the door in a first open position. When the protrusions 114A-B are positioned in the second positioning notch 110B, the arm surface 112 extends from the outer body 102 in a second, intermediate position, positioning the door in a second open position that is greater than the first. When the protrusions 114A-B are positioned in the third positioning notch 110C, the arm surface 112 extends from the outer body 102 in a third, maximal position, positioning the door in a third open position that is greater than the first and second positions.

Referring to FIG. 4, a rear perspective view of the inner positioning arm 104 illustrates the configuration of protrusions 114A-B on the inner positioning arm 104. The first protrusion 114A and the second protrusion 114B may be positioned on opposite sides of the inner positioning arm 104, each on an opposite side and near the base of the handle 111.

With continued reference to FIG. 4, the coupling aperture 118 of the fulcrum 115 of the inner positioning arm 104 is visible. The coupling aperture 118 may be configured to align with the coupling aperture 120 on the outer body 102 when the inner positioning arm 104 is received within the slot 116 of the outer body 102. The rod 122 may be inserted through the coupling aperture 118 to couple the inner positioning arm 104 to the outer body 102, with the rod 122 functioning as a pivot point that allows the inner positioning arm 104 to pivot in relation to the outer body 102.

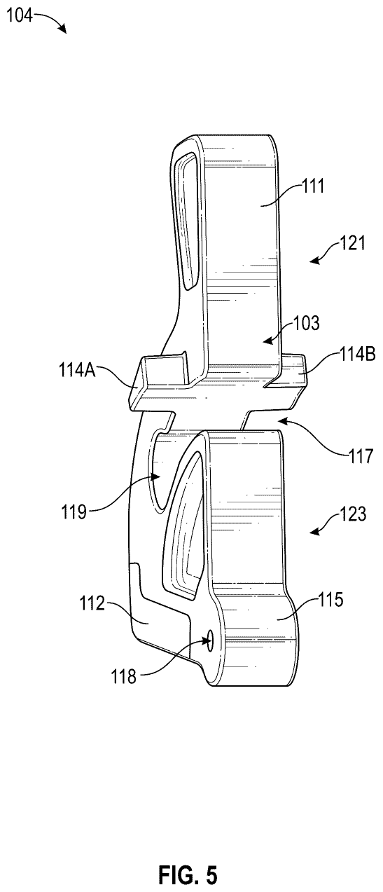

Referring to FIG. 5, a front perspective view of the inner positioning arm 104 further illustrates the arrangement of the first protrusion 114A, the second protrusion 114B, the aperture 117, and fulcrum 115. As shown, an upper body portion 121, which includes the handle 111 and protrusions 114A-B is separated from a lower body portion 123 via the aperture 117. The aperture 117 commencing on an inner surface 103 and extending through the main body 105 toward the arm surface 112 where it terminates in a circular portion 119, forming the spring.

With continued reference to FIG. 5, the first protrusion 114A and the second protrusion 114B may be configured to selectively mate with the positioning notches of the outer body 102, including the first positioning notch 110A, the second notch 110B, and the third notch 110C. The selective engagement between the first protrusion 114A and the second protrusion 114B with the positioning notches 110A, 110B, 110C may allow a user to set different angular positions for a door when the door is in an open position. The arrangement of the first protrusion 114A and the second protrusion 114B on opposite sides of the inner positioning arm 104 may enable engagement with corresponding notches on opposite sides of the outer body 102, thereby providing a secure connection between the inner positioning arm 104 and the outer body 102 at each selected position.

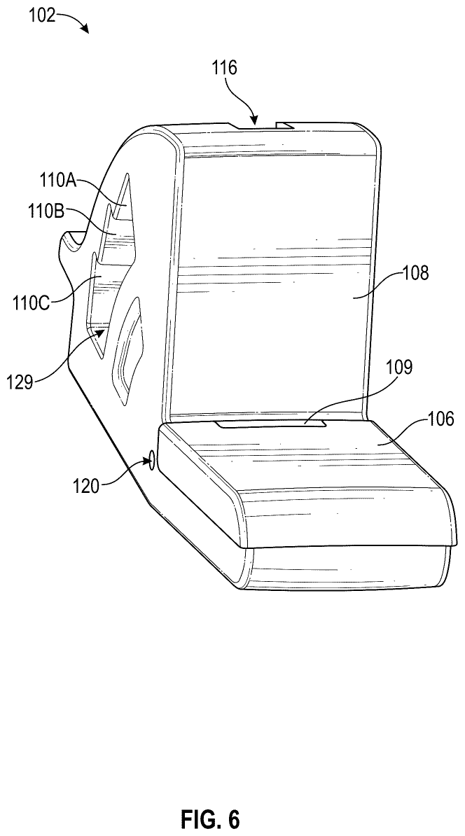

Referring to FIG. 6, a front perspective view of the outer body 102 illustrates the arrangement of surfaces and positioning notches 110A-C on the outer body 102. The first surface 106 may extend along a lower portion of the outer body 102 and may be configured for abutting a first side of a door when the doorstop 100 is in use. The second surface 108 may extend along an upper portion of the outer body 102 and may be configured for abutting an edge of a door. The first surface 106 and the second surface 108 may be arranged in an L-shaped configuration, with the first surface 106 and the second surface 108 meeting at an angle.

With continued reference to FIG. 6, the first positioning notch 110A, the second notch 110B, and the third notch 110C may be positioned in sequence along the outer body 102. The positioning notches 110A, 110B, 110C may be configured to selectively receive the protrusions 114A-B on the inner positioning arm 104 to set different door angles when a door is in an open position. The coupling aperture 120 may be provided on the outer body 102 and may be configured to align with the coupling aperture 118 on the inner positioning arm 104 to receive the rod 122 that functions as a pivot point.

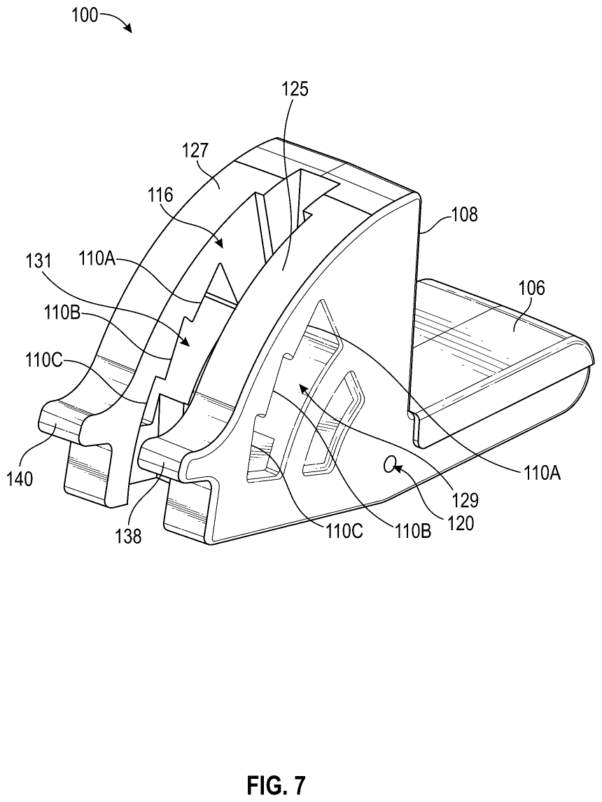

Referring to FIG. 7, a right side perspective view of the outer body 102 further illustrates the configuration of the outer body 102. The first surface 106 and the second surface 108 are visible in this view, demonstrating the spatial relationship between these surfaces. The first positioning notch 110A, the second notch 110B, and the third notch 110C may be arranged in a curved configuration along an interior portion of the outer body 102. The curved arrangement of the positioning notches 110A, 110B, 110C may correspond to an arc of travel of the protrusions on the inner positioning arm 104 as the inner positioning arm 104 pivots relative to the outer body 102.

As further shown in FIG. 7, the slot 116 may be formed within the outer body 102, forming a first side 125 comprising positioning notches 110A-C, and a second side 127 comprising a corresponding set of positioning notches 110A-C. In other words, the slot 116 is interposed between the first and second sides 125, 127. It will be understood that the first protrusion 114A engages a respective positioning notch 110A-C on the first side 125 and the second protrusion 114B engages a respective positioning notch 110A-C on the second side 127. As understood, the first side 125 and second side 127 may be independently manufactured and coupled together using fasteners (e.g., screws), adhesives, or other coupling mechanisms.

As shown best shown in FIGS. 6-8, each of the first side 125 and the second side 127 includes a single elongated aperture (129 and 131, respectively) that includes a plurality of discrete positioning notches 110A-C along an arcuate path corresponding to the pivot arc of the inner positioning arm 104. The slot 116 may define a channel within which the inner positioning arm 104 may be positioned and may pivot. The first side 125 may have a first rear-extending protrusion 138 and the second side 127 may comprise second rear-extending protrusion 140. The first and second rear-extending protrusions 138, 140 may act as a prop point against a doorjamb, ensuring that the doorstop 100 remains positioned within the doorjamb without unwanted movement, as will be shown later herein. In use, rear-extending protrusions 138 and 140 act as prop points against a doorjamb surface to resist rotational slippage of outer body 102 when the door exerts force on surfaces 106 and 108.

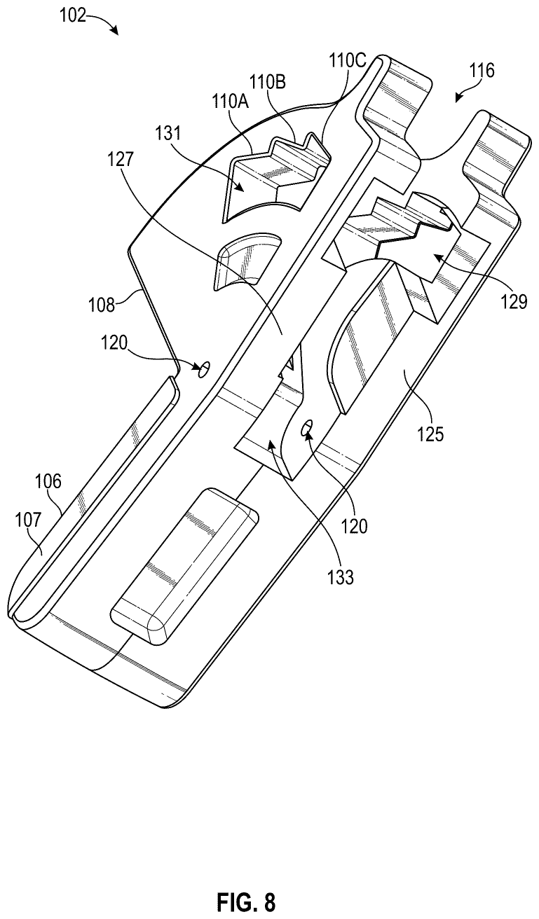

Referring to FIG. 8, a bottom perspective view of the outer body 102 reveals additional details of the internal structure of the outer body 102. The slot 116 may extend through the outer body 102 and may be configured to receive the inner positioning arm 104, allowing the inner positioning arm 104 to pivot relative to the outer body 102. The fulcrum 115 is received within a corresponding fulcrum aperture 133 shaped complementary to the fulcrum 115 so as to allow the fulcrum 115 to rotate in the fulcrum aperture via rod 122 while limiting lateral play.

The first positioning notch 110A, the second notch 110B, and the third notch 110C may be arranged in sequence within an interior portion of the outer body 102. The bottom perspective view may reveal how the positioning notches 110A, 110B, 110C are positioned within the outer body 102 relative to the slot 116. The arrangement of the positioning notches 110A, 110B, 110C within the outer body 102 may enable the protrusions 114A-B of the inner positioning arm 104 to engage with a selected positioning notch 110A-C when the inner positioning arm 104 is received within the slot 116 and pivoted to a desired position. The outer body 102 may provide a structural framework for the doorstop 100 and may enable adjustable positioning functionality through the interaction between the positioning notches 110A, 110B, 110C and the protrusions 114A-B of the inner positioning arm 104.

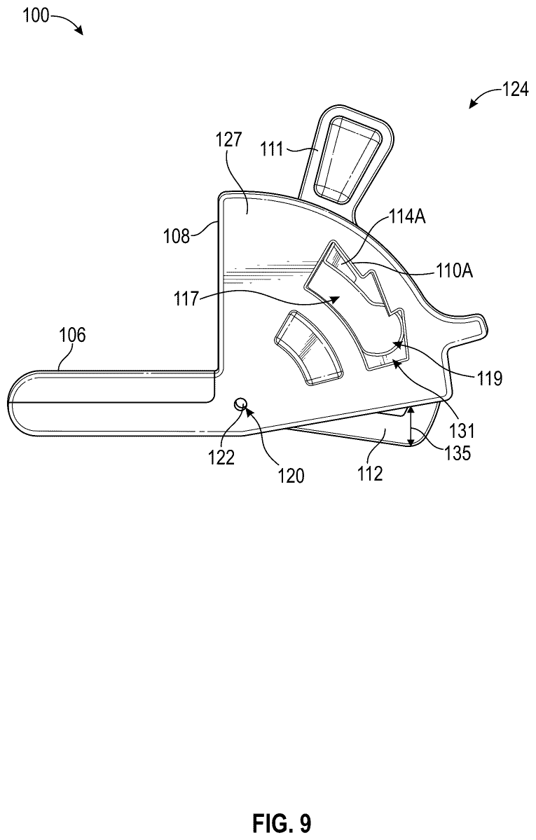

Referring to FIG. 9, the doorstop 100 is shown in a first position 124. In the first position 124, the first protrusion 114A may be engaged with the first positioning notch 110A on the second side 127. Although not visible in this view, it is understood that the second protrusion 114B is engaged with a corresponding positioning notch 110A on the first side 125 of the outer body 102 when the doorstop 100 is in the first position 124.

With continued reference to FIG. 9, the arm surface 112 may extend from the bottom of outer body 102 at a first distance when the inner positioning arm 104 is in the first position 124. The first distance may correspond to a first angle for a door when the doorstop 100 is in use.

As further shown in FIG. 9, the rod 122 may couple the inner positioning arm 104 to the outer body 102 and may function as a pivot point. The engagement between the first protrusion 114A and the first positioning notch 110A may secure the inner positioning arm 104 in the first position 124, wherein the arm surface 112 protrudes from the bottom surface of outer body 102 a first distance 135. The circular portion 119 may provide a biasing force that maintains the engagement between the first protrusion 114A and the first positioning notch 110A during operation of the doorstop 100.

When the doorstop 100 is in the first position 124 and interposed between a door and a doorjamb on a hinge side of the door, the arm surface 112 may contact the doorjamb while the first surface 106 and the second surface 108 contact the door, thereby maintaining the door at a first angle (e.g., approximately 90 degrees).

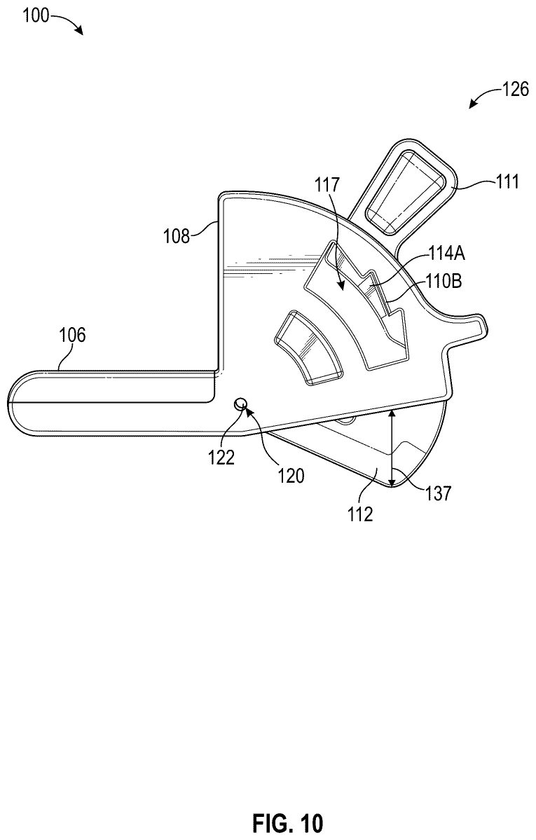

Referring to FIG. 10, the doorstop 100 is shown in a second position 126. In the second position 126, the first protrusion 114A may be engaged with the second notch 110B. Although not visible the second protrusion 114B is engaged with a corresponding notch 110B on an opposite side of the outer body 102 when the doorstop 100 is in the second position 126.

With continued reference to FIG. 10, the arm surface 112 may extend from the outer body 102 at a second distance 137 when the inner positioning arm 104 is in the second position 126. The second distance 137 may be greater than the first distance 135 at which the arm surface 112 extends from the outer body 102 when the inner positioning arm 104 is in the first position 124. The second distance 137 may correspond to a second angle for a door when the doorstop 100 is in use. The second angle being wider than the first angle, thereby holding a door at a wider opening than when the doorstop 100 is in the first position 124.

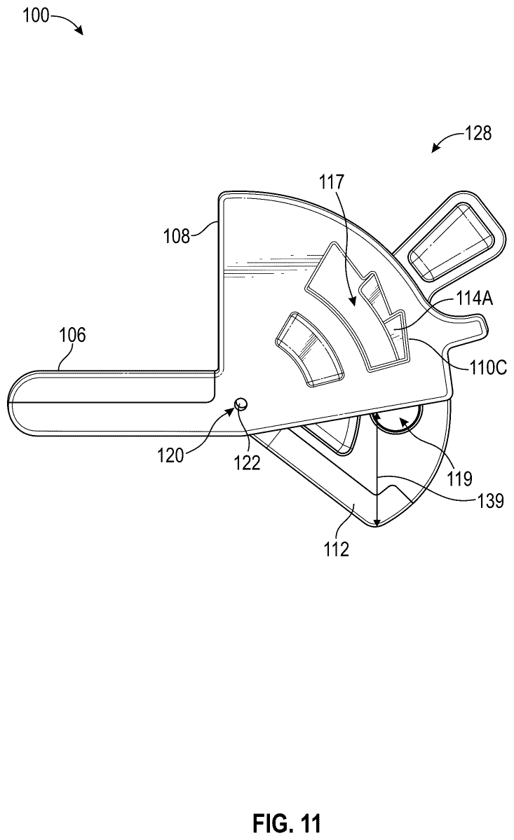

As further shown in FIG. 10, the rod 122 may couple the inner positioning arm 104 to the outer body 102 and may function as a pivot point. The engagement between the first protrusion 114A and the second notch 110B may secure the inner positioning arm 104 in the second position 126. The first surface 106 may be configured for abutting a first side of a door, and the second surface 108 may be configured for abutting an edge of a door when the doorstop 100 is interposed between the door and a doorjamb. The second position 126 may provide an intermediate door opening configuration between the first position 124 and a third position 128 (FIG. 11), allowing a user to select a door angle that is wider than the first angle while maintaining the door in an open position.

Referring to FIG. 11, the doorstop 100 is shown in a third position 128. In the third position 128, the first protrusion 114A may be engaged with the third positioning notch 110C. Although not shown in this view, the second protrusion 114B is engaged with a corresponding notch 110C on an opposite side of the outer body 102 when the doorstop 100 is in the third position 128.

With continued reference to FIG. 11, the arm surface 112 may extend from the outer body 102 at a third distance 139 when the inner positioning arm 104 is in the third position 128. The third distance 139 may be greater than the second distance 137 at which the arm surface 112 extends from the outer body 102 when the inner positioning arm 104 is in the second position 126. The third distance 139 may correspond to a third angle for a door when the doorstop 100 is in use. The third angle being wider than the second angle, thereby holding a door at a wider opening than when the doorstop 100 is in the second position 126.

As further shown in FIG. 11, the rod 122 may couple the inner positioning arm 104 to the outer body 102 and may function as a pivot point. The engagement between the first protrusion 114A and the third notch 110C may secure the inner positioning arm 104 in the third position 128. The first surface 106 may be configured for abutting a first side of a door, and the second surface 108 may be configured for abutting an edge of a door when the doorstop 100 is interposed between the door and a doorjamb. The third position 128 may allow a user to hold a door at a maximum opening angle among the available positions, providing the widest door opening configuration of the first position 124, the second position 126, and the third position 128.

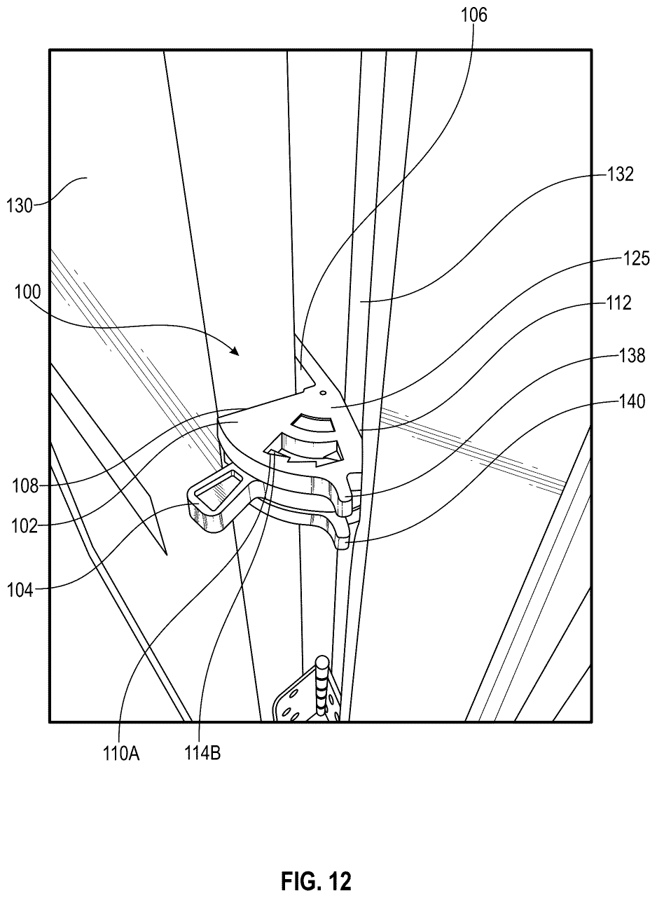

Referring to FIG. 12, the doorstop 100 is shown in use with a door 130 and a doorjamb 132. The doorstop 100 may be interposed between the door 130 and the doorjamb 132 on a hinge side of the door 130. In this configuration, the outer body 102 may be positioned against the door 130, with the first surface 106 abutting a first side of the door 130 and the second surface 108 abutting an edge of the door 130. The inner positioning arm 104 may extend from the outer body 102, with the arm surface 112 contacting the doorjamb 132.

With continued reference to FIG. 12, the doorstop 100 is shown in the first position 124. In the first position 124, the second protrusion 114B may be engaged with the first positioning notch 110A of the first side 125. The engagement between the second protrusion 114B and the first positioning notch 110A may secure the inner positioning arm 104 in the first position 124, thereby holding the door 130 at a first angle relative to the doorjamb 132. The doorstop 100 may maintain the door 130 in an open position without requiring placement on a ground surface, thereby avoiding dependency on ground surface type or angle.

In some methods of use, a user may determine a desired angle for the door 130 prior to installing the doorstop 100. The user may actuate the inner positioning arm 104 within the outer body 102 to select a desired position before inserting the doorstop 100 between the door 130 and the doorjamb 132. The user may actuate the inner positioning arm 104 so that the second protrusion 114B mates with a selected positioning notch of the first positioning notch 110A, the second positioning notch 110B, or the third positioning notch 110C. Once the desired position is selected, the user may open the door 130 and insert the doorstop 100 on the hinge side of the door 130, interposing the doorstop 100 between the door 130 and the doorjamb 132.

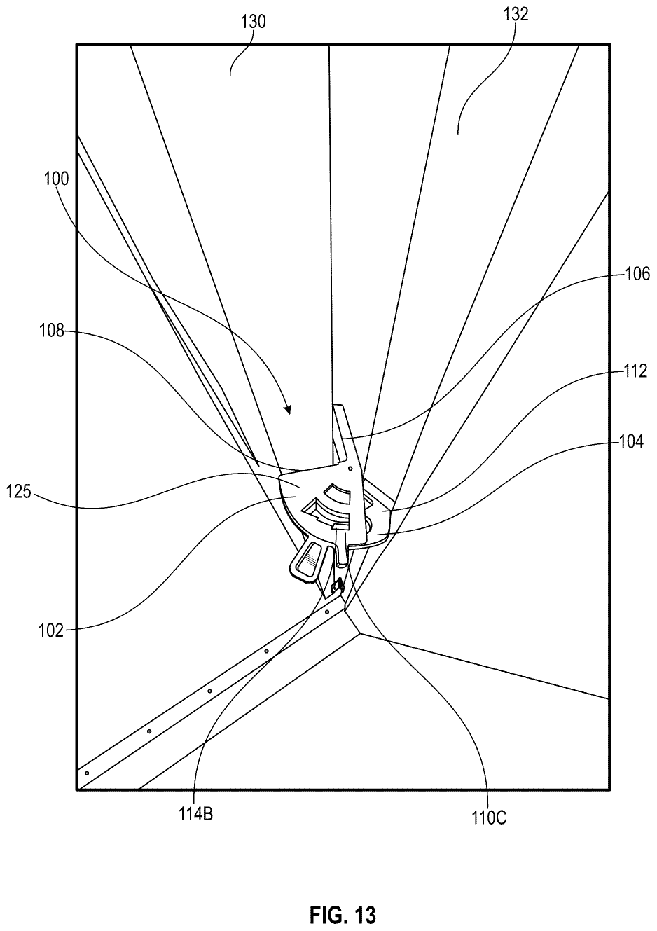

Referring to FIG. 13, the doorstop 100 is shown in the third position 128 while in use with the door 130. In the third position 128, the second protrusion 114B may be engaged with the third positioning notch 110C of the first side 125, with the first protrusion 114A engaged with a third positioning notch 110C of the second side 127. The engagement between the first and second protrusions 114A-B and the third notch 110C may cause the arm surface 112 to extend at a greater distance from the outer body 102 compared to the first position 124. The extended configuration of the arm surface 112 may force the door 130 to open at a wider angle than when the doorstop 100 is in the first position 124.

With continued reference to FIG. 13, if a different angle is desired while the doorstop 100 is in use, the user may actuate the inner positioning arm 104 in relation to the outer body 102 to a different position. The user may actuate the inner positioning arm 104 from the first position 124 to the second position 126 or the third position 128 to increase the door angle. Alternatively, the user may actuate the inner positioning arm 104 from the third position 128 to the second position 126 or the first position 124 to decrease the door angle. The ability to actuate the inner positioning arm 104 to different positions while the doorstop 100 is interposed between the door 130 and the doorjamb 132 may allow the user to adjust the door angle without removing the doorstop 100 from between the door 130 and the doorjamb 132, although the doorstop 100 may also be actuated while not in position.

To actuate the doorstop 100 between the positions 124, 126, 128, a user applies an inward force, forcing the handle 111 inward toward the outer body 102, thereby compressing the size of the aperture 117. This allows the respective protrusions 114A-B to be released from the respective positioning notch 110A-C, whereupon a user may then pivot the handle 111 until the protrusions 114A-B engage the desired positioning notch 110A-C corresponding to a desired open angle of a door.

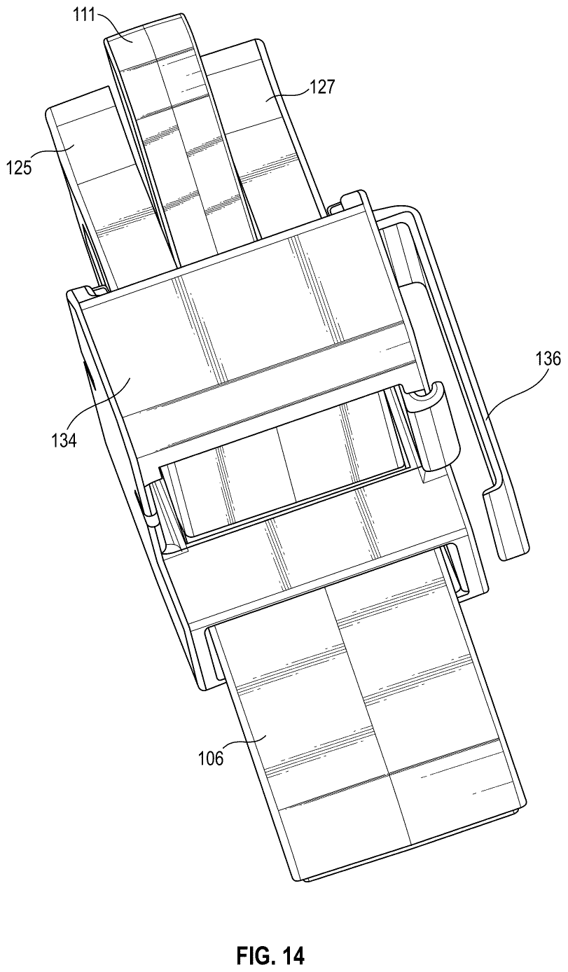

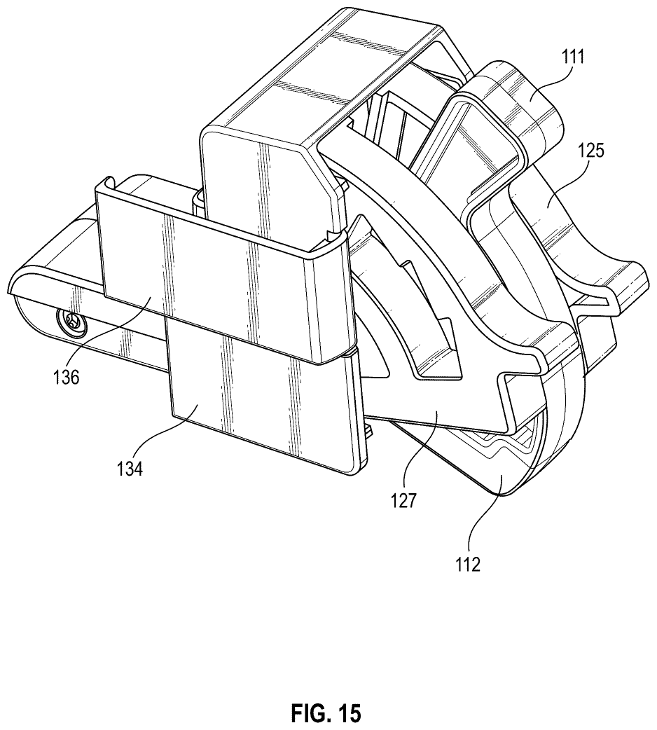

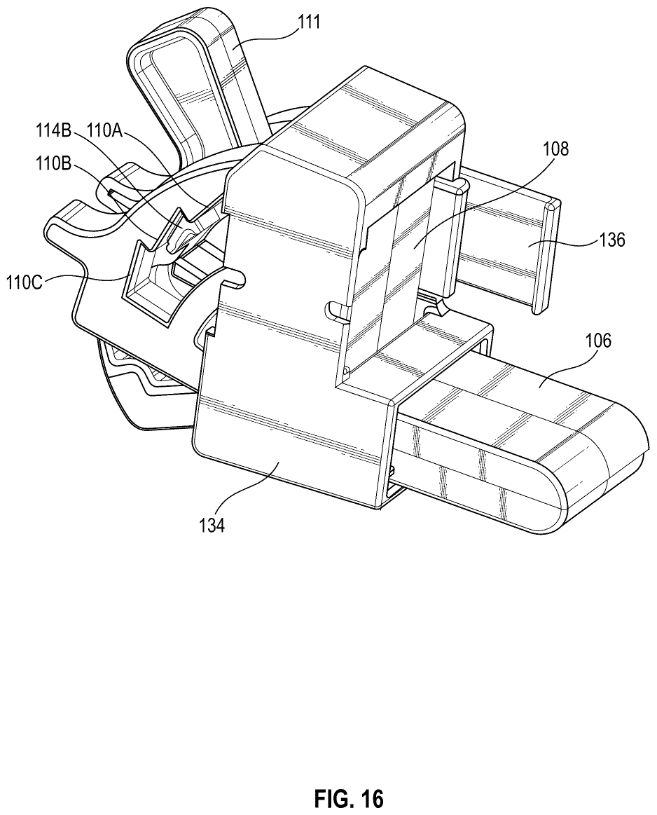

Referring to FIGS. 14-16, in some embodiments, the doorstop 100 may further comprise a sleeve 134 having a belt clip 136, effectively functioning as a holster for a user. The sleeve 134 may be configured to slide over the first surface 106 and partially overlap the outer body 102. The sleeve 134 may remain coupled via interference fit, but may also comprise securing mechanisms, such as locking tabs, tongue and groove, latches, snaps, or any other coupling mechanism. A user may utilize the belt clip 136 to easily store and transport the doorstop 100 on their person when not in use. When the user desires to prop open a door, the user may easily retrieve the doorstop 100 from their belt and insert it into the doorjamb at the desired angle.

Accordingly, it will be appreciated from the foregoing that the doorstop 100 disclosed herein solves the need in the art for a doorstop which does not require bending and placing heavy objects, does not create a tripping hazard, works on most door types, and that is not dependent on the ground surface type or angle.

While a door was used as an example herein, it will be appreciated that the doorstop 100 may also be used with gates, panels, or other hinged devices without departing herefrom. Additionally, while three positioning notches 110A-C were shown and described, more or fewer may be used without departing herefrom.

It will be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

1. A doorstop for use in a doorjamb, the doorstop comprising:
an outer body having a first surface for abutting a first side of a door, a second surface for abutting an edge of the door, and a plurality of positioning notches; and
an inner positioning arm having an arm surface for abutting a doorjamb and one or more protrusions for selectively mating with a respective positioning notch of the plurality of positioning notches, wherein the protrusions and positioning notches are configured to set a selected angle of the door when in an open position.

2. The doorstop of claim 1, wherein the outer body comprises a slot and wherein the inner positioning arm is at least partially received within the slot.

3. The doorstop of claim 1, wherein the inner positioning arm comprises a coupling aperture that aligns with a coupling aperture of the outer body, and wherein a rod is inserted through the coupling apertures to pivotably couple the inner positioning arm to the outer body.

4. The doorstop of claim 3, wherein the rod functions as a pivot point, allowing the inner positioning arm to pivot in relation to the outer body.

5. The doorstop of claim 1, wherein the inner positioning arm comprises an aperture terminating in a circular portion configured, in combination with a material elasticity of the inner positioning arm, to provide a biasing return without a separate spring.

6. The doorstop of claim 1, wherein the plurality of positioning notches comprises a first positioning notch, a second positioning notch, and a third positioning notch.

7. The doorstop of claim 6, wherein the one or more protrusions are configured to engage with the first positioning notch in a first position, wherein an arm surface of the inner positioning arm extends from the outer body at a first distance, setting a first angle.

8. The doorstop of claim 7, wherein the one or more protrusions are configured to engage with the second positioning notch in a second position, wherein the arm surface extends from the outer body at a second distance greater than the first distance, setting a second angle.

9. The doorstop of claim 8, wherein the one or more protrusions are configured to engage with the third positioning notch in a third position, wherein the arm surface extends from the outer body at a third distance greater than the second distance, setting a third angle.

10. The doorstop of claim 1, wherein the one or more protrusions comprise a first protrusion and a second protrusion positioned on opposite sides of the inner positioning arm.

11. The doorstop of claim 1, wherein the doorstop is configured to be interposed between the door and the doorjamb on a hinge side of a door.

12. A doorstop for use in a doorjamb, comprising:
an outer body having a first surface configured to contact a door and a slot extending through a portion of the outer body;
an inner positioning arm received within the slot, the inner positioning arm having an arm surface configured to contact a doorjamb; and
a rod inserted through a coupling aperture of the inner positioning arm and a coupling aperture of the outer body, the rod pivotably coupling the inner positioning arm to the outer body for rotation about a fulcrum portion of the inner positioning arm received in a complementary fulcrum aperture of the outer body.

13. The doorstop of claim 12, wherein the inner positioning arm comprises a handle opposite the arm surface, and an aperture separating the handle and the arm surface, the aperture terminating in a stress-relief geometry configured to elastically bias the handle toward a rest position.

14. The doorstop of claim 12, wherein the outer body further comprises a plurality of positioning notches, and wherein the inner positioning arm comprises one or more protrusions configured to selectively mate with a respective positioning notch of the plurality of positioning notches to set an angle of a door when in an open position.

15. The doorstop of claim 14, wherein the plurality of positioning notches comprises a first positioning notch, a second positioning notch, and a third positioning notch arranged in a curved configuration along the outer body that follows an arc of travel of the inner positioning arm about the rod.

16. The doorstop of claim 15, wherein the one or more protrusions comprises a first protrusion and a second protrusion positioned on opposite sides of the inner positioning arm, the first protrusion and the second protrusion configured to engage with corresponding positioning notches on opposite sides of the outer body.

17. A method of using a doorstop with a doorjamb, comprising:
selecting a position of an inner positioning arm relative to an outer body corresponding to a desired door angle;
actuating an inner positioning arm within an outer body so that one or more protrusions of the inner positioning arm mate with a selected positioning notch of a plurality of positioning notches of the outer body;
opening the door; and
inserting the doorstop on a hinge side of the door, interposing the doorstop between the door and the doorjamb.

18. The method of claim 17, further comprising actuating the inner positioning arm in relation to the outer body to a different position to change the angle of the door.

19. The method of claim 17, wherein the outer body has a first surface for abutting a first side of the door and a second surface for abutting an edge of the door.

20. The method of claim 19, wherein the inner positioning arm has an arm surface for abutting the doorjamb, and wherein the protrusions and the plurality of positioning notches are configured to set the angle of the door when in an open position.
